(19) United States
(12) Patent Application Publication
(10) Pub. No.: US 2026/0058383 A1
(43) Pub. Date: Feb. 26, 2026

(54) ELECTRICAL CONNECTION STRUCTURE

(71) Applicant: DENSO CORPORATION, Kariya-city (JP)

(72) Inventors: TOSHIKI YASUE, Kariya-city (JP); YUKITAKA MAKINO, Kariya-city (JP)

(21) Appl. No.: 19/302,705

(22) Filed: Aug. 18, 2025

(30) Foreign Application Priority Data
Aug. 21, 2024 (JP) 2024-140016

(51) Int. Cl. H01R 12/67; H01R 12/62

(52) U.S. Cl. CPC H01R 12/67; H01R 12/62; H01R 2201/18; H01R 2201/26

(57) ABSTRACT

An image sensor as an electrical connection structure includes a flexible circuit board and a connector that is electrically connected to the flexible circuit board. The flexible circuit board has terminals with a conductive property formed on a surface of a substrate portion and an insulator layer with an electrical insulation property formed to cover the terminals. The connector has connecting protrusions formed to individually correspond to a corresponding one of the terminals. During assembling the connector and the flexible circuit board, at least one of the connecting protrusions breaks and penetrates the insulation layer to come in contact with the corresponding one of the terminals and establishes an electrical connection between the connector and the flexible circuit board.

### CROSS REFERENCE TO RELATED APPLICATIONS

The present application is based on and claims the benefit of priority from Japanese Patent Application No. 2024-140016 filed in Japan filed on Aug. 21, 2024, the entire disclosure of the above application is incorporated herein by reference.

### TECHNICAL FIELD

The present disclosure relates to an electrical connection structure.

### BACKGROUND

An electrical connection structure establishes an electrical connection among several circuit units, especially between two circuit units. The electrical connection structure is required to establish a proper electrical connection and suppress an improper electrical connection. In the above aspects, or in other aspects not mentioned, there is a need for further improvements in an electrical connection structure.

### SUMMARY

One of an aspect disclosed herein is an electrical connection structure, comprising: a flexible circuit board; and a connection target component to be connected that is electrically connected to the flexible circuit board, wherein
the flexible circuit boards includes:
a substrate portion formed in a ribbon shape with a flexible property;
a terminal with a conductive property formed on a surface of the substrate portion; and
an insulator layer with an electrical insulation property formed to cover the terminals from a side of the terminals opposite to the substrate portion, and wherein
the connection component includes:
a housing portion with an electrical insulation property having a closely attaching surface formed to closely attach to the insulator layer; and
a connecting protrusion that is formed to correspond individually to the terminal with a conductive property and to protrude from a side of the closely attaching surface of the housing portion, and electrically connects the connection target component and the flexible circuit board by penetrating the insulator layer and coming in contact with corresponding one of the terminal.

According to such an embodiment, it is possible to closely attach the housing portion of the connection target component to the flexible circuit board via the closely attaching surface by having the insulator layer on the flexible circuit board even in an area opposite to the terminal portion. It is possible to suppress adverse accidents to electrically conduct unintended terminals by entering conductive foreign matters between the flexible circuit board and the housing portion. On the other hand, it is required to take additional improvement to achieve a proper conduction due to a presence of an insulator layer. Therefore, in this embodiment, the connecting protrusion on the connection target component to be connected protrude from a side of the closely attaching surface, break through the insulator layer, and comes in contact with corresponding one of the terminal. Therefore, it is possible to suppress the entry of conductive foreign matter while facilitating a proper conduction. Therefore, it is possible to provide an electrical connection structure that suppresses an occurrence of improper electrical connection conditions.

Note that the reference signs in parentheses in this specification, e.g., Claims, exemplarily indicate a correspondence relationship with the portions of the embodiments to be described later, and are not intended to limit the technical scope.

### BRIEF DESCRIPTION OF DRAWINGS

FIG. 1 is a diagram showing a mounting structure of an image sensor on a vehicle.

FIG. 2 is a perspective view showing the image sensor.

FIG. 3 is a diagram showing a connector and a flexible circuit board in the image sensor.

FIG. 4 is a cross sectional view showing a state before assembling the flexible circuit board to the connector.

FIG. 5 is a cross sectional view showing a state after assembling the flexible circuit board to the connector.

FIG. 6 is a diagram explaining a positional relationship of a connecting projection, terminal, and a pressing portion.

FIG. 7 is a cross sectional view showing a state after assembling the flexible circuit board to the connector.

FIG. 8 is a diagram explaining another example of a connecting projection.

### DETAILED DESCRIPTION

JP2023-93132A discloses a technology for electrically connecting a flexible circuit board and another connection target component such as a connector.

However, there is a concern that in technologies such as those described in JP2023-93132A, conductive foreign matter with conductive properties may enter into gaps, etc. formed in a connection area between the flexible circuit board and the connection target component, causing electrical continuity to unintended terminals, or so-called short defects. Conductive foreign matters are, e.g., pieces of screws used for fastening parts or pieces of plating that have been stripped from screws or other plating on parts.

It is an object of this disclosure in this specification to provide an electrical connection structure that suppresses an occurrence of improper electrical connection conditions.

Hereinafter, a plurality of embodiments are described with reference to the drawings. It should be noted that the same reference numerals are assigned to the corresponding components respectively in the respective embodiments, so that duplicative descriptions may be omitted. When only a part of the configuration is described in one embodiment, the other parts of the configuration may employ descriptions about a corresponding configuration in another embodiment preceding the one embodiment. Further, not only the combinations of the configurations explicitly shown in the description of the respective embodiments, but also the configurations of the plurality of embodiments can be partially combined even if they are not explicitly shown if there is no problem in the combinations in particular.

### First Embodiment

An electrical connection structure according to the first embodiment is an image sensor 10. The image sensor 10 is mounted on a vehicle and captures images of a vehicle's external environment. The images captured by the image sensor 10 are used to recognize dynamic objects and static objects in the external environment, such as other vehicles, pedestrians, obstacles, and road signs.

If the vehicle is configured for autonomous operation, the image is used for autonomous driving applications. In other words, the vehicle is operated under an action planning based on recognized objects, and is controlled based on a result of the action planning.

If the vehicle is configured to assist manual operations of the driver, the image is used for driver assistance applications. The driver assistance applications may be a road sign assist that displays recognized road signs on an in-vehicle display device. The driver assistance applications may be an Autonomous Emergency Braking (AEB) to prevent collisions with objects due to driver manual driving errors, etc.

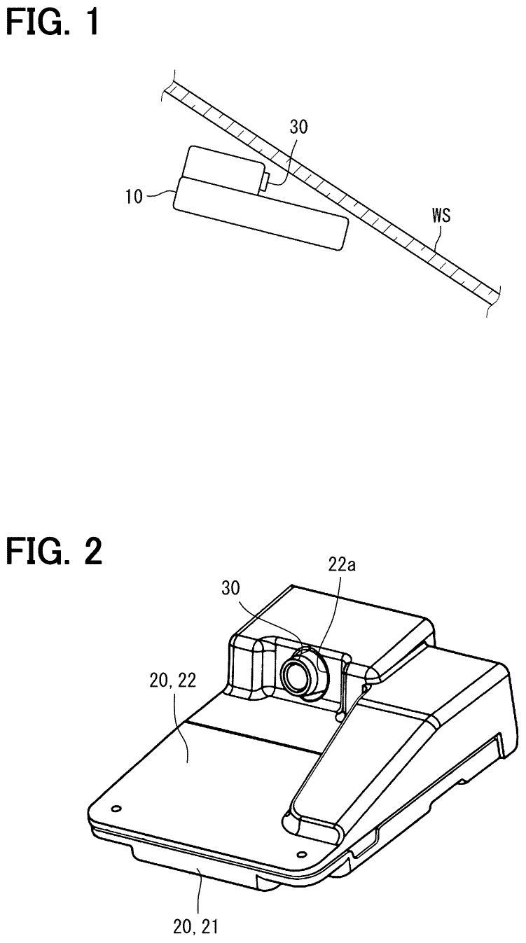

As shown in FIG. 1, an image sensor 10 is configured to be mounted on an inside of a front windshield WS of a vehicle, at a position that is less likely to obstruct a driver's view. In the following, directions of forward, backward, up, down, left, and right are used in explanations with respect to the vehicle on the horizontal plane on which the image sensor 10 is mounted.

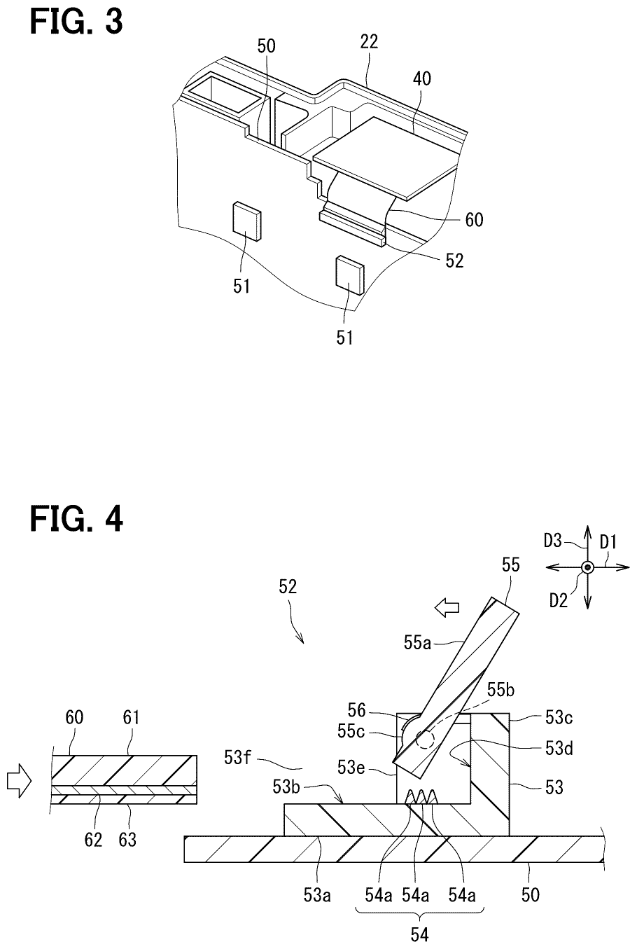

As shown in FIG. 2 and FIG. 3, the image sensor 10 includes a case portion 20, a lens module 30, a camera board 40, a control board 50, and a flexible circuit board 60. The case portion 20 is formed in a hollow box shape by combining a lower case 21 and an upper case 22 with each other to accommodate the lens module 30, the camera board 40, the control board 50, and the flexible circuit board 60. The lower case 21 and the upper case 22 are formed, e.g., of metal or synthetic resin. The lower case 21 is formed to fit the shape of the control substrate 50, covering it from below. The lower case 21 may be referred to as a cover and the upper case 22 may simply be referred to as a case.

The upper case 22 is assembled by fastening it to the lower case 21 by screws, for example. The upper case 22 is formed to cover the lens module 30, the camera board 40, and the control board 50 from above. The upper case 22 has an opening 22a to expose a lens barrel of the lens module 30 to an outside of the case portion 20. By exposing the lens barrel to the outside of the case portion 20 in an oriented posture facing the forward of the vehicle, the image sensor 10 can capture images of the environment in front of the vehicle.

The camera substrate 40 is located behind an aperture 22a and is formed of a hard and a flat plate shape, e.g., made of synthetic resin. The camera substrate 40 is fixedly held to the upper case 22 in an upright posture so that it is perpendicular to the optical axis of the lens module 30. The camera board 40 is assembled with the lens module 30 thereon and is also assembled with a light-receiving element such as a CCD sensor or CMOS sensor that converts light formed by the lens module 30 into electrical signals. Along with this, a connector is mounted on the camera board 40 to output the electrical signals from the light-receiving element to an outside of the camera board 40. The camera board 40 transmits electrical signals toward the control board 50 by electrically connecting the flexible circuit board 60 to the connector.

The control substrate 50 is positioned below the lens module 30 and is formed of, e.g., synthetic resin in the form of a rigid flat plate having a larger size than the camera substrate 40. The control substrate 50 is fixedly held to the upper case 22 in a posture extended in a substantially vertical direction relative to the camera substrate. Wiring patterns and various electronic components 51 including one or more processors and one or more memories are mounted on a mounting surface of the control board 50.

The control board 50 is mounted with a connector 52 for electrically connecting the flexible circuit board 60. In this way, the processor on the control board 50 acquires and processes the electrical signals transmitted from the camera board 40, and generates image data that can be recognized as video images.

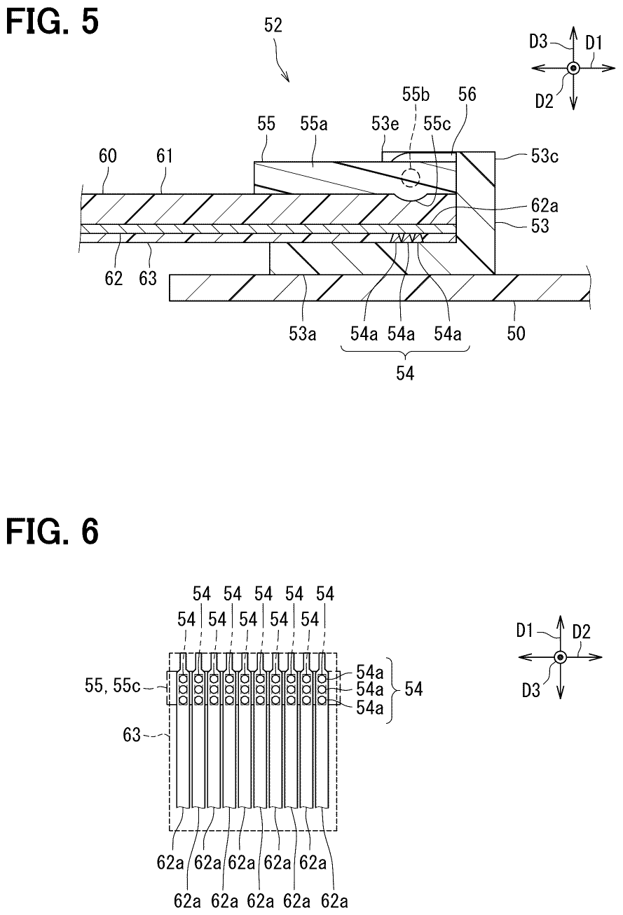

The flexible circuit board 60 is a circuit board formed in a ribbon shape with a flexible property and may be referred to as a flexible cable. The flexible circuit board 60 has a substrate portion 61, a wiring pattern 62, and an insulator layer 63, as also shown in FIG. 4 and FIG. 5. The flexible circuit board 60 may be, e.g., an FPC (Flexible Printed Circuit), which is formed by printing wiring patterns 62 with a conductive property on the substrate portion 61.

The substrate portion 61 is a base material to ensure a physical strength of the flexible circuit board 60. The substrate portion 61 is formed of a synthetic resin, such as polyimide, e.g., in the form of a film that is flexible by having substantially the same constant thickness throughout, and has a ribbon shape.

The wiring patterns 62 are formed on at least one side of the substrate portion 61, e.g., by a metal such as copper. In this embodiment, the wiring patterns 62 are formed on one side of the substrate portion 61. The wiring patterns 62 can be formed by photolithography, for example. The wiring patterns 62 includes a plurality of terminals 62a at distal end of the flexible circuit board 60 that is connected to the connector 52 on the control board 50.

The insulator layer 63 is formed of synthetic resin, e.g., in the form of a film with an electrical insulation property. The insulator layer 63 protects the wiring patterns 62 by covering the substrate portion 61 and the wiring pattern 62. Here, the insulator layer 63 covers the entirety of the plurality of terminals 62a formed at the distal end of the flexible circuit board 60. Furthermore, it is desirable that the insulator layer 63 is formed over the entire portion of the surface of the flexible circuit board 60 that is in contact with a closely attaching surface 53b (described later) of the connector 52. The insulator layer 63 is formed by widening a cover area of a protective film to cover the terminals 62a, which is usually formed for protecting a surface of a circuit portion of the flexible circuit board 60 by means of a cover-lay, a solder resist, etc. formed to expose the terminals 62a. The insulator layer 63 is formed by a material with higher elasticity than the terminals 62a and the housing portion 53.

The details of the connector 52 and its connection to the flexible circuit board 60 are explained here using FIG. 4 and FIG. 5. FIG. 4 shows a state that is in a manufacturing process before assembling the flexible circuit board 60 to the connector 52, and shows a state in which the connector 52 is not connected to the flexible circuit board 60. FIG. 5 shows a state that is the in-vehicle mounted state after assembling the flexible circuit board 60 to the connector 52, and shows a state in which the connector 52 is connected to the flexible circuit board 60. In the following description, an insertion direction in which the flexible circuit board 60 is inserted into the connector 52 is referred to as a first direction D1. The direction orthogonal to the first direction D1 and along a mounting surface of the control substrate 50 is referred to as a second direction D2. The direction orthogonal to the first direction D1 and the second direction D2 and substantially perpendicular to the mounting surface of the control substrate 50 is referred to as a third direction D3.

The connector 52 is configured to include the housing portion 53, a plurality of connecting protrusion units 54, a clamp member 55, and an engagement member 56. The housing portion 53 is made of, e.g., a synthetic resin with an electrical insulation property and is formed in a box shape with an open portion 53f that is open in the first direction D1. The housing portion 53 has a bottom portion 53a, a back wall portion 53c, and side wall portions 53e formed integrally.

The bottom portion 53a is extended in a flat shape along the mounting surface of the control substrate 50. The bottom portion 53a is fixedly held against the control substrate 50 at its bottom surface. The bottom portion 53a has a closely attaching surface 53b with a flat shape attaching to the flexible circuit board 60 in the connected state, which is a surface facing a side of the bottom portion 53a opposite to the control substrate 50 and is configured to enable positioning of the flexible circuit board 60 in the first direction D1.

The back wall portion 53c is formed as a flat wall protruding in the second direction D2 from an end of the bottom portion 53a in the first direction D1 opposite the open portion 53f. The back wall portion 53c has a colliding surface 53d with a flat surface configured to perform positioning of the flexible circuit board 60 in the first direction D1 by colliding an end of the flexible circuit board 60 against it.

The side wall portions 53e are formed as a pair of flat walls protruding in the second direction D2 from both ends of the bottom portion 53a in the second direction D2. The pair of side wall portions 53e are spaced apart from each other to match a width of the flexible circuit board 60, thereby enabling positioning of the flexible circuit board 60 in the second direction D2. The pair of side wall portions 53e also have a support portion that supports the clamp member 55 in a rotatable manner.

Each one of the connecting protrusion unit 54 is configured with one or more connecting protrusion 54a, which are formed of a metal such as copper and have conductive properties. The number of connecting protrusions 54a belonging to each one of the connecting protrusion unit may be the same to each other or may be different. For example, in this embodiment, all connecting protrusion units 54 have three pieces of the connecting protrusions 54a.

The connecting protrusions 54a belonging to the same one of the connecting protrusion unit 54 are electrically connected to the same one of the wiring patterns in the control board 50. The connecting protrusions 54a belonging to a common one of the connecting protrusion unit 54 are electrically connected to separate pieces of the wiring patterns in the control board 50. As shown in FIG. 6, the plurality of connecting projection units 54 are arranged in a line along the second direction D2. Each one of the connecting protrusions 54a belonging to the same one of the connecting protrusion unit 54 are arranged along a line in the first direction D1.

The connecting protrusion unit 54 corresponds individually, one-to-one, to one of the plurality of terminals 62a of the flexible circuit board 60. As shown in FIG. 6, in the in-vehicle mounted state, an extending direction of each one of the terminals 62a is coincide with the first direction D1, which is the alignment direction of the plurality of connecting protrusions 54a belonging to the same connecting protrusion unit 54. As a result, each one of the connecting protrusions 54a belonging to the same one of the connecting protrusion unit 54 is arranged to face the terminal 62a that corresponds individually to that of the connecting protrusion unit 54, that is, corresponds commonly to each one of the connecting protrusion 54a, in the third direction D3.

Each one of the connecting projections 54a is formed protruding along the third direction D3 so as to extend from the closely attaching surface 53b of the bottom portion 53a toward the clamping member 55. As a result, in the state shown in FIG. 5, each one of the connecting projections 54a breaks through the insulator layer 63 and comes in contact with the terminal 62a corresponding to that. As shown in FIG. 4, the terminals 62a are not exposed at all because the insulator layer 63 covers whole of the terminals 62a in a state before the flexible circuit board 60 is assembled to the connector 52. However, when the flexible circuit board 60 is assembled, the connecting protrusion 54a strikes against the insulator layer 63 along the third direction D3, breaking and penetrating the insulator layer 63. As a result, each one of the connecting protrusion 54a comes in contact with the corresponding one of the terminal 62a, and a circuit side of the connector 52 and a circuit side of the flexible circuit board 60 are electrically connected.

Here, the connecting protrusion 54a may be formed as a needle, cone, triangular pyramid, square pyramid, hemisphere, cone base, triangular pyramid, square pyramid, cylinder, triangular prism, square prism, etc. The connecting projection 54a may be shaped with a rotational symmetry with respect to a center of the projection, or with linear symmetry across a line of symmetry along the first direction D1 and the second direction D2. On the other hand, the connecting protrusions 54a may be formed in an asymmetric shape that does not have such symmetry.

The connecting protrusions 54a should be shaped to allow penetrating through the insulator layer 63, while not damaging the terminal 62a. Therefore, even if the connecting protrusion 54a is formed in the shape of a cone, triangular pyramid, or square pyramid, for example, it is preferable that a distal end of the protrusion is rounded rather than pointed.

The clamp member 55 is formed of, e.g., synthetic resin and integrally has a plate portion 55a, a rotation shaft 55b, and a pressing portion 55c. The clamp member 55 is supported by the pair of the side wall portions 53e and is rotatable around the rotation shaft 55b.

The plate portion 55a is a main part of the clamp member 55, which is formed in a flat plate shape. The rotation shaft 55b is provided at an end of the plate portion 55a so that it penetrates along the second direction D2. The rotation shaft 55b may be formed as projections that fit into recesses or holes formed as support portions in each one of the side wall portions 53e. By rotating around the rotation shaft 55b, the plate portion 55a can switch between an open posture (see FIG. 4) and an engaged posture (see FIG. 5). In the open posture, the plate portion 55a faces in the first direction D1 and makes the connector 52 in the open posture. In the engaged posture, the plate portion 55a is oriented to face the closely attaching surface 53b (with the flexible circuit board 60 in between) to fixedly holds (locks) the flexible circuit board 60.

The pressing portion 55c is located on a side of the plate portion 55a that faces the flexible circuit board 60 and the bottom portion 53a in the engaged posture, at a position opposing the connection projection unit 54 and the flexible circuit board 60. The pressing portion 55c is formed as a cam shape protruding from the plate portion 55a. The pressing portion 55c is formed, for example, in a partial cylindrical shape with the second direction D2 as the baseline direction. A height at which the pressing portion 55c protrudes from the plate portion 55a may be equivalent to a thickness of the insulator layer 63.

The pressing portion 55c presses the flexible circuit board 60 toward the connection projection unit 54 in the engaged posture. Such pressing force facilitates the penetration of the insulator layer 63 by the connecting protrusions 54a. It also improves an attaching property between the closely attaching surface 53b of the bottom portion 53a and the flexible circuit board 60.

The engagement member 56 is a member for maintaining the clamp member 55 in an engaged posture. As an example, the engagement member 56 is an elastic member (e.g., a leaf spring) formed of metal. One end of the engagement member 56 is connected to one of the back wall portion 53c and the side wall portions 53e, and the other end is connected to the clamp member 55. When the clamp member 56 is rotated to a position where the clamp member 55 is in the engaged posture, the engagement member 56 demonstrates elastic force in a direction of holding the plate portion 55a and the pressing portion 55c toward the flexible circuit board 60. Such elasticity improves the attaching property between the closely attaching surface 53b of the bottom portion 53a and the flexible circuit board 60, making it difficult for conductive foreign matter to enter between the bottom portion 53a and the flexible circuit board 60.

According to the first embodiment described above, it is possible to closely attach the housing portion 53 of the connector 52 as the connection target component to the flexible circuit board 60 via the closely attaching surface 53b by having the insulator layer 63 on the flexible circuit board 60 even in an area opposite to the terminal 62a. It is possible to suppress adverse accidents to electrically conduct unintended terminals by entering conductive foreign matters between the flexible circuit board 60 and the housing section 53. On the other hand, it is required to take additional improvement to achieve a proper conduction due to a presence of an insulator layer 63. Therefore, in this embodiment, the connecting projection 54a on the connector 52 protrudes from a side of the closely attaching surface 53b and breaks through the insulator layer 63 to come in contact with the corresponding one of the terminal 62a. Therefore, it is possible to suppress the entry of conductive foreign matter while facilitating a proper conduction. Therefore, it is possible to provide an electrical connection structure that suppresses an occurrence of improper electrical connection conditions.

According to the first embodiment, the connector 52 further has a pressing portion 55c that presses the flexible circuit board 60 from a side of the flexible circuit board 60 opposite to the connecting protrusion 54a to assist penetration of the insulator layer 63 by the connecting protrusion 54a. Since a proper conduction is more easily achieved by a pressing force by the pressing portion 55c, the effect of suppressing an occurrence of an improper electrical connection state is further enhanced.

According to the first embodiment, the pressing portion 55c is formed in a cam shape with a protruding shape in the clamp member 55 which fixedly holds the flexible circuit board 60. It is possible to generate a stable pressing force by the cam structure.

According to the first embodiment, the insulator layer 63 is formed by extending an area of the protective film protecting the surface of the flexible circuit board 60 to cover the terminals 62a. By widening the protective film to form the insulator layer 63, the increase in the variety of raw materials in the manufacture of the flexible circuit board 60 can be controlled, and the process of forming the insulator layer 63 can be simplified. By reducing manufacturing costs, an electrical connection structure that suppress an occurrence of improper electrical connection conditions can be easily provided.

According to the first embodiment, a plurality of connecting protrusions 54a are provided with respect to a corresponding one of the terminals 62a. With this configuration, even if one of the connecting protrusion 54a fails to penetrate the insulator layer 63 during assembly of the flexible circuit board 60, a proper conduction can still be achieved if the other one of the connecting protrusion 54a succeeds. Thus, by providing redundancy in the connecting protrusions 54a, the effect of suppressing an occurrence of an improper electrical connection state is further enhanced.

### Second Embodiment

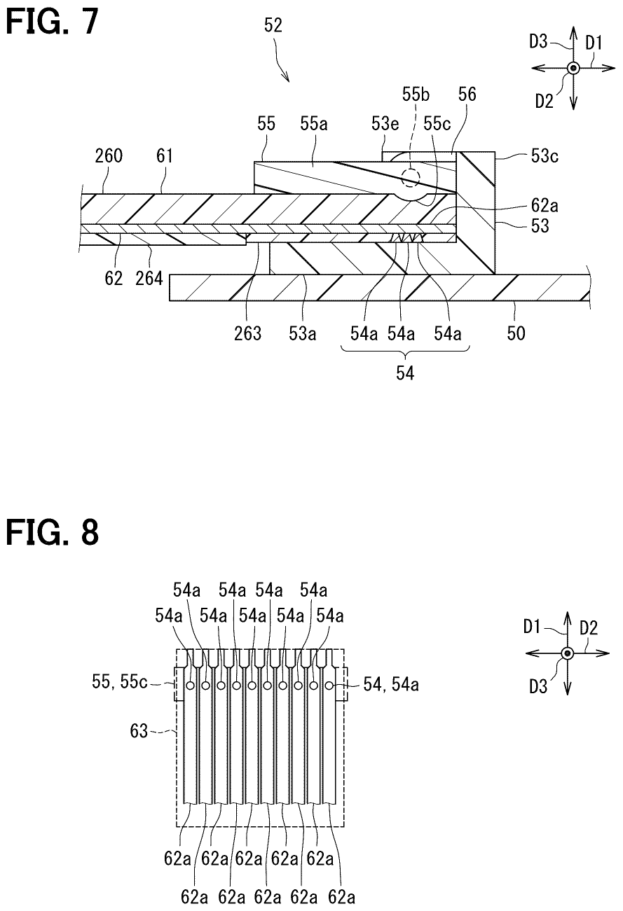

As shown in FIG. 7, a second embodiment is a modification to the first embodiment. The second embodiment is described focusing on matters different from the first embodiment.

In the flexible circuit board 260 of the second embodiment, the insulator layer 263 to be penetrated with the connecting protrusions 54a is formed separately from a protective film 264 that protects a surface of the flexible circuit board 260. In other words, the protective film 264 is formed by a cover lay, a solder resist, or the like, and covers an area of a circuit portion of the flexible circuit board 260, excluding an area occupied by the plurality of terminals 62a.

On the other hand, the insulator layer 263 covers the area of the flexible circuit board 260 that is occupied by the plurality of terminals 62a. The insulator layer 263 may or may not overlap the protective film 264 in the third direction D3. Even if there is an overlap, a portion penetrated by the connecting protrusion 54a must be formed to restrict overlap with the protective film 264.

The insulator layer 263 is formed so that a breaking strength thereof is lower than that of the protective film 264. The breaking strength is an indicator of the strength or durability of a material, meaning the maximum tensile or compressive force that the material can withstand before it breaks. In other words, by suppressing the breaking strength of the insulator layer 263 to a low level, the connecting protrusions 54a can easily penetrate the insulator layer 263 when the flexible circuit board 260 is assembled to the connector 52. The insulator layer 263 may be formed as a relatively soft film (e.g., a film with higher elasticity than the terminals 62a and the housing portion 53) with an ink material having an electrical insulation property applied to a thin synthetic resin base tape, such as that used for correction tape. It is desirable that the insulator layer 263 is formed thinner than the protective film 264.

In this configuration where the insulator layer 263 and the protective film 264 are formed with different thicknesses and steps, it is more preferable that the closely attaching surface 53b is in contact only with the insulator layer 263, not with the protective film 264, among the insulator layer 263 and the protective film 264. This is because it is more difficult for gaps to occur between the housing portion 53 and the flexible circuit board 260.

According to the second embodiment described above, the flexible circuit board 260 has a protective film 264 that protects a surface thereof in an area away from the terminals 62a. The insulator layer 263 is formed separately from the protective film 264 to cover the terminal 62a and has a lower rupture strength than the protective film 264. As a result, a dedicated insulator layer 263 is provided, which facilitates piercing by the connecting protrusions 54a. Therefore, a proper conduction is more easily achieved, it is possible to further enhance an effectiveness of suppressing an occurrence of improper electrical connection conditions.

### Other Embodiments

Although a plurality of embodiments have been described above, the present disclosure is not to be construed as being limited to these embodiments, and can be applied to various embodiments and combinations within a scope not deviating from the gist of the present disclosure.

As another embodiment, only one of the connecting protrusion 54a may be provided for each one of the terminals 62a, as shown in FIG. 8. In other words, only one terminal 62a may belong to one connecting protrusion unit 54.

As another embodiment related to the first embodiment, a portion of the insulator layer 63 that is penetrated by the connecting protrusion 54a may be formed thinner than the other portions.

As another embodiment, the clamp member 55 may not have a pressing portion 55c and may be configured to press the flexible circuit board 60 by the plate portion 55a.

In other embodiments, the electrical connection structure may correspond to a component that is part of the image sensor.

In other embodiments, the electrical connection structure may be applied to other than the image sensor. For example, the electrical connection structure may be applied to the flexible circuit board and the connector that connect a display panel and a control board in a liquid crystal display, an OLED (Organic Light Emitting Diode) display, etc. mounted in vehicles. For example, the electrical connection structure may be applied to devices for consumer products, for commercial products, for overtime products, or for medical products other than for in-vehicle products.

### Disclosure of Technical Concepts

This description discloses a plurality of technical ideas described in a plurality of sections listed below. Some items may be written in a multiple dependent form with subsequent items referring to the preceding item as an alternative. These sections written in the multiple dependent form define a plurality of technical ideas.

<Technical Idea 1> An electrical connection structure, comprising:
a flexible circuit board (60, 260); and
a connection target component (52) that is electrically connected to the flexible circuit board, wherein
the flexible circuit board includes:
a substrate portion (61) formed in a ribbon shape with a flexible property;
a terminal (62a) with a conductive property formed on a surface of the substrate portion; and
an insulator layer (63, 263) with an electrical insulation property formed to cover the terminals from a side of the terminals opposite to the substrate portion, and wherein
the connection component includes:
a housing portion (53) with an electrical insulation property having a closely attaching surface (53b) formed to closely attach to the insulator layer; and
a connecting protrusion (54a) that is formed to correspond individually to the terminal with a conductive property and to protrude from a side of the closely attaching surface of the housing portion, and electrically connects the connection target component and the flexible circuit board by penetrating the insulator layer and coming in contact with corresponding one of the terminal.

<Technical Idea 2> The electrical connection structure according to Technical Idea 1, wherein the connection target component further includes: a pressing portion (55c) that presses the flexible circuit board from a side of the flexible circuit board opposite to the connecting protrusion to assist penetration of the insulator layer by the connecting protrusion.

<Technical Idea 3> The electrical connection structure according to Technical Idea 2, wherein the pressing portion is formed in a form of a cam shape protruding in a clamp member (55) which fixedly holds the flexible circuit board.

<Technical Idea 4> The electrical connection structure according to any one of Technical Ideas 1-3, wherein the insulator layer (63) is formed by extending an area of a protective film that protects a front surface of the flexible circuit board to cover the terminal.

<Technical Idea 5> The electrical connection structure according to any one of Technical Ideas 1-3, wherein the flexible circuit board (260) has a protective film (264) to protect a surface thereof in an area away from the terminal, and wherein the insulator layer (263) is formed separately from the protective film to cover the terminal and has a lower breaking strength than the protective film.

<Technical Idea 6> The electrical connection structure according to any one of Technical Ideas 1-5, wherein the connecting protrusion is provided in a plurality of pieces corresponding to one of the terminal.

<Technical Idea 7> The electrical connection structure according to any one of Technical Ideas 1-6, wherein the electrical connection structure is applied to an image sensor mounted in a vehicle.

What is claimed is:

1. An electrical connection structure, comprising:
a flexible circuit board; and
a connection target component that is electrically connected to the flexible circuit board, wherein
the flexible circuit board includes:
a substrate portion formed in a ribbon shape with a flexible property;
a terminal with a conductive property formed on a surface of the substrate portion; and
an insulator layer with an electrical insulation property formed to cover the terminal from a side of the terminal opposite to the substrate portion, and wherein
the connection target component includes:
a housing portion with an electrical insulation property having a closely attaching surface formed to closely attach to the insulator layer; and
a connecting protrusion that is formed to correspond individually to the terminal with a conductive property and to protrude from a side of the closely attaching surface of the housing portion, and electrically connects the connection target component and the flexible circuit board by penetrating the insulator layer and coming in contact with corresponding one of the terminal.

2. The electrical connection structure according to claim 1, wherein
the connection target component further includes:
a pressing portion that presses the flexible circuit board from a side of the flexible circuit board opposite to the connecting protrusion to assist penetration of the insulator layer by the connecting protrusion.

3. The electrical connection structure according to claim 2, wherein
the pressing portion is formed in a form of a cam shape protruding in a clamp member which fixedly holds the flexible circuit board.

4. The electrical connection structure according to claim 1, wherein
the insulator layer is formed by extending an area of a protective film that protects a front surface of the flexible circuit board to cover the terminal.

5. The electrical connection structure according to claim 1, wherein
the flexible circuit board has a protective film to protect a surface thereof in an area away from the terminal, and wherein
the insulator layer is formed separately from the protective film to cover the terminal and has a lower breaking strength than the protective film.

6. The electrical connection structure according to claim 1, wherein
the connecting protrusion is provided in a plurality of pieces corresponding to one of the terminal.

7. The electrical connection structure according to claim 1, wherein
the electrical connection structure is applied to an image sensor mounted in a vehicle.
